(19) United States
(12) Patent Application Publication
(10) Pub. No.: US 2009/0229560 A1
(43) Pub. Date: Sep. 17, 2009

(54) INTERNAL COMBUSTION ENGINE HAVING A REDUCED CYLINDER HEAD HEIGHT

(75) Inventor: Derek Woodcroft, Weert (NL)

Correspondence Address: GIFFORD, KRASS, SPRINKLE,ANDERSON & CITKOWSKI, P.C, PO BOX 7021, TROY, MI, 48007-7021, US

(73) Assignee: FEV MOTORENTECHNIK GMBH, Aachen (DE)

(21) Appl. No.: 11/914,816

(22) PCT Filed: May 17, 2006
(86) PCT No.: PCT/EP2006/004672

§ 371 Date: May 8, 2009

(30) Foreign Application Priority Data
May 18, 2005 (DE) 10 2005 023 581.6

(51) Int. Cl. F02F 3/00; F01L 1/00

(52) U.S. Cl. 123/193.6; 123/188.9

(57) ABSTRACT

An internal combustion engine according to the invention comprises at least one cylinder and at least one valve provided for a gas exchange and having a first end comprising a valve head, and a second end, characterized in that a valve bearing has a length of a guidance area arranged for the guidance of a valve stem of at most 25%, preferably between 10 and 20%, and particularly preferably of less than 10% of a valve length.

### CROSS-REFERENCE TO RELATED APPLICATIONS

This application is the U.S. national phase of international patent application PCT/EP2006/004672 filed May 17, 2006, which claims priority to German patent application DE 102005 023 581.6 filed May 18, 2005.

### FIELD OF THE INVENTION

The invention concerns an internal combustion engine comprising at least one cylinder and at least one valve provided for a gas exchange.

### BACKGROUND OF THE INVENTION

Numerous configurations of such internal combustion engines are known from prior art.

The problem of the invention is to reduce a structural height of a cylinder head as well as, in particular, to reduce a moved mass in controlling a gas exchange valve.

### SUMMARY OF THE INVENTION

This problem is solved by an internal combustion engine with the characteristics of Claim 1. Advantageous configurations and refinements are indicated in the respective dependent claims.

An internal combustion engine according to the invention comprises at least one cylinder and at least one valve provided for a gas exchange and having a first end comprising a valve head, and a second end, characterized in that a valve bearing has a length of a guidance area arranged for the guidance of a valve stem of at most 25%, preferably between 10 and 20%, and particularly preferably of less than 10% of a valve length.

The internal combustion engine is, for example, an internal combustion engine operating according to the spark-ignition or the diesel principle. In particular such an internal combustion engine is provided in a vehicle, for example, an automobile. For instance, it may be an internal combustion engine in a passenger car.

The valve bearing is preferably designed to be complementary to the valve stem accommodated in it. For a valve stem with a circular cross section, for example, the valve bearing comprises an appropriate circular bore for the guidance of the valve stem. The guidance area here is to be understood, in particular, as the area which is in direct contact with the valve stem. The guidance area is preferably provided to prevent lateral tilting of the valve stem. In particular, the valve is movably guided in its longitudinal direction in the valve bearing, so that a gas intake or gas exhaust port can be opened and closed with the valve disk in a stroke of the valve. Moreover, the valve can be moved back and forth between an open and a closed position by means of at least one reset spring in connection with actuation equipment, for example. In place of a valve closing spring, a forced control of the valve can be provided. Both a mechanical and an electromechanical drive, in particular, an electromagnetic drive can be provided for actuating the valve.

The valve bearing can be represented in different ways. For example, the valve bearing may be formed by a guidance machined into the cylinder head. This is preferably provided for a cylinder head of cast iron. In particular, the guidance has a hardened surface. In another variant, a valve bushing can be arranged in the cylinder head as a valve bearing. This variant is preferably used in a light-metal cylinder head of, for example, aluminum or another light metal or a light metal alloy.

In a first configuration, it is provided that the guidance area has a length of at most 18 mm, preferably between 18 mm and 10 mm, more preferably between 10 mm and 5 mm, and most preferably between 5 mm and 2 mm. A valve length here is, for example, approximately 85 mm. This data is preferably related to a four-cylinder gasoline engine with a displacement of approximately 2 L. The cylinder head with a reduced valve bearing length expediently has a smaller overall size compared to an ordinary valve bearing length. Additionally, the valve preferably has a smaller length and thus a lower mass than is the case for an ordinary valve bearing length. In particular the moved mass of the valve is reduced.

In another configuration it is provided that a valve stem diameter A in an area guided by the valve bearing, a first distance B between a lower edge of the valve disk and an upper edge of the envelope circle described during one revolution of a cam associated with the valve, as well as a second distance C between an end face provided at the second end of the valve for the transmission of an actuating force and a lower edge of the valve bearing are selected such that a product of second distance C and valve stem diameter A, divided by the square of the first distance B, is at most 0.0125, preferably between 0.011 and 0.0125, more preferably between 0.0105 and 0.011, and most preferably less than 0.0105, where the first distance B and second distance C in the direction of a central axis of the cylinder are relative to the closing position of the valve. The valve stem diameter A in the area of valve stem guided by the valve bearing is preferably constant over this area. The valve stem diameter of the valve can also vary over the length of the valve. For instance, a valve stem diameter outside the area guided by the valve bearing can be larger or smaller than inside the area guided by the valve bearing. In particular, the closed position is determined by the fact that the valve head rests against the associated valve seat in the cylinder head and closes off an associated gas intake port. In the case of an overhead valve, the valve is in an upper end position in the closed position. The cam associated with the valve is preferably provided for direct or indirect actuation of the valve. In the rotation of the cam it passes over a circular surface, which is preferably arranged along a valve axis. An axis of rotation of the cam can be arranged such that it forms an intersection with an extension of a longitudinal axis of the valve. It can also be arranged offset thereto, however. The valve is preferably oriented along the main axis of the cylinder. However, a slanted installation and thus an angle to the main axis of the cylinder can also be provided. In case an electromechanical valve drive without a camshaft is used, a distance between the lower edge of the valve head and the upper edge of a volume occupied or passed through during an actuation process with the electromechanical valve drive can be used for the first distance B, instead of the distance between the lower edge of the valve head and the upper edge of the cam's envelope curve.

The end face is, for example, a cylinder end face of the valve stem. The end surface can additionally be, for instance, a plate or the like that is mounted on the second end.

In another configuration it is provided, additionally or ultimately, that a valve stem diameter in an area guided by the valve bearing, as well as a second distance C between an end face provided at the second end for transmitting an actuation force and a lower edge of the valve bearing are selected such that a product of second distance C and valve stem diameter A is at most 250 mm², preferably between 230 mm² and 250 mm², more preferably between 210 mm² and 230 mm², and most preferably less than 210 mm², wherein a second distance C in the direction of a main axis of the cylinder is relative to a closed position of the valve. These values can be used, for instance, in an internal combustion engine with a valve length of roughly 85 mm. Preferably, a valve length is between 95 mm and 75 mm. This may be, for example, an internal combustion engine operating according to the spark-ignition principle with four cylinders and a displacement of roughly 2 L. Other internal combustion engines can also be provided, such as a three cylinder internal combustion engine with a displacement of roughly 1000 cm³ or an internal combustion engine with eight cylinders and a displacement of roughly 4000 cm³.

Alternatively or additionally, it is provided in an additional configuration that the length of the guidance area divided by the valve stem diameter in an area guided by the valve bearing is at most 4, preferably between 3 and 4, more preferably between 2 and 3, and most preferably less than 2.

According to another concept, a second distance C between an end face arranged at the second end of the valve for transmitting an actuation force and a lower edge of the valve bearing, divided by the guidance length of the valve bearing, is at least 3, preferably between 3 and 5, more preferably between 5 and 7, and most preferably greater than 7, relative to a closing position of the valve.

According to another configuration, the end face is formed by a cup which is connected via a form fit or a force fit to the second end of the valve. A cup is mounted by means of a clamp connection, for instance, in another variant. The cup is preferably connected to the valve stem so as to be reversibly detachable. A non-reversibly detachable connection can also be provided, however.

The cup can preferably be fixed in a longitudinal direction of the valve stem in various positions, which correspond to different end lengths of the valve. The end length of the valve is to be understood as the distance between valve head and cup surface. A fixation in various positions is ensured, for instance, by means of a threaded connection or a clamp connection.

According to one refinement, the cup is guided in a cup guide. For a cup with a cylindrical side surface, the cup guide is constructed as a bushing with a complementary shape in cross section, for example. The guide can extend over the entire periphery of the cup; in another variant, however, it can be provided that only certain areas of the cup's periphery are guided. The cup guide preferably absorbs transverse forces of the valve stem. A stiffening of the cylinder head is also effected by the cup guide, for instance. In particular, the cup guide, in connection with the guidance area of the valve stem, forms a second guidance area which extends from a lower edge of the guidance area of the valve bearing to an upper edge of the cup guide. The second guidance length is preferably between 35% and 65% of the valve length. In particular, a lateral tilting is avoided or at least reduced, despite a smaller valve bearing length. Additionally, a guidance length effective for guidance of the valve is preferably considerably increased in comparison with a guidance without a cup guide. In particular, the arrangement has an a comparatively large effective guidance length despite a small overall height.

For improved heat removal it can be provided that a cup of aluminum or an aluminum alloy is used. Accordingly, a suitable friction pairing between cup guide and cup is selected in order to minimize wear. For instance, can be correspondingly selected as a material of the cup guide. The friction partner can additionally be case-hardened or have a wear-protection coating.

According to another refinement, the cup guide is directly formed in a cylinder head. For instance, a bushing may be formed in a casting process of the cylinder. Additionally, a bushing for cup guidance can be directly cast into the cylinder head, for example.

It is provided in another configuration for the cup guide to be formed by a cap placed on a cylinder head. The cap in this case is a socket, for instance. It is preferably attached to the cylinder head by a threaded fastener, by pressing, or the like.

In a preferred configuration, a valve is guided with its valve stem in a lower guide formed by the valve bearing, and in an upper guide in the cylinder head with a tappet firmly connected at an upper end and forming an upper spring retainer or with a hydraulic valve clearance compensation element, wherein at least one compression spring is pressed in between the upper spring retainer and a lower spring retainer.

According to an additional concept, a length of the valve bearing exceeds the length of the guidance area, preferably by at least 50%. For instance, the valve bearing is formed by a valve bearing bushing which has a larger bore diameter over a first part of its length than in the guidance area. Tilting of the valve bearing in the cylinder head is preferably reduced by a sufficient length of the valve there. A precise orientation of the guidance area with respect to the valve stem is correspondingly improved. In one configuration, an excess of more than 200% can be provided.

A seat of the valve bearing in the cylinder head in a preferred configuration has a clearance fit or a transition fit. A press fit is specifically avoided. Preferably, tensions in the cylinder head normally occurring in the case of a press fit are minimized. In particular, this is a tight clearance fit. According to one variant, the valve bearing, in particular a valve bearing bushing, can be held in place by a valve spring. A rotation of the valve bearing is preferably prevented as much as possible.

It can be provided in another configuration that a seat of the valve bearing in a cast-iron cylinder head has a fit with an oversize of at least 0.02 mm. In particular, an outside diameter of the valve bearing is dimensioned 0.02 mm larger than an inside diameter of a receptacle provided for the valve bearing in the cast-iron cylinder head. Preferably only slight tensions are induced in the cylinder head in the vicinity of the valve bearing due to the slight oversize.

In a cylinder head having a material from the group comprising aluminum, aluminum alloy, magnesium and magnesium alloy, it is provided according to one refinement that a seat of the valve bearing in the cylinder head has an oversize of less than 0.04 mm. Preferably only slight tensions are introduced by the valve bearing in the cylinder head here as well. For an aluminum cylinder head with a valve bearing made of cast iron, an oversize of 30 μm is provided. In particular a bore for accommodating the valve bearing has a tolerance as in conformity with an H7 fit according to DIN Standard 7157. The valve bearing accordingly has an outside diameter tolerance conforming to an s7 fit corresponding to the same standard. These values are preferably relative to room temperature.

For an improved cooling, it is preferably provided that the valve has at least one sodium core. For instance, the valve stem has at least one cavity for this purpose. The latter is preferably filled only fractionally with sodium, for example, to about two-thirds.

Alternatively or additionally, it is also preferably provided for improved cooling that a wall thickness between the valve bearing and at least one coolant space in the environs of the guidance area of the valve bearing is less than 5 mm in at least one section, preferably between 3 mm and 5 mm, and most preferably between 1 mm and 3 mm. In particular, heat dissipation from the valve stem into the coolant space via the valve bearing is improved. The environs of the guidance area are to be understood in particular as the direct environment of the valve inside roughly one stem diameter. The coolant space preferably carries water from a water-cooling circuit. Oil cooling can additionally be provided. In another configuration, a direct cooling of the valve bearing can be provided in connection with an appropriate seal.

Controlling of the valve for carrying out a stroke motion can be realized in various ways. In a first configuration, the internal combustion engine has a rocker arm control. For example, one end of the rocker arm acts on the end face of the valve's end. The rocker arm is preferably likely driven by the camshaft.

In another configuration, the internal combustion engine has a cam lever control. Here, for instance, one end of the cam lever acts on the end face of the second valve, with another end of the cam lever resting against a bearing. The cam lever is again preferably controlled by the camshaft. Lateral forces on the valve stem are preferably minimized with a cam lever control.

In another variant, it is provided that the internal combustion engine has a direct camshaft control of the cup. Here, one cam of a camshaft control preferably acts directly on the cup that is mounted at the second end of the valve. In particular, an induction of lateral forces onto the valve is also minimized with a tappet arrangement.

In another configuration, the valve is an overhead valve. This preferably allows an optimally simple construction of a valve control.

According to an additional concept, the internal combustion engine comprises at least one hydraulic clearance compensation element. This is, for instance, a hydraulic tappet. The clearance compensation element is preferably used to compensate the valve clearance. There is preferably an automatic compensation of the valve clearance.

### BRIEF DESCRIPTION OF THE DRAWINGS

The invention will be described in detail below on the basis of the drawing. The characteristics there are not restricted to the individual configurations, however. Rather, the characteristics contained in the specification, including the description of the figures and or the drawing, can be combined for refinements.

Shown are:

FIG. 1, a first cylinder head arrangement according to prior art,

FIG. 2, a second cylinder head arrangement,

FIG. 3, a third cylinder head arrangement,

FIG. 4, a fourth cylinder head arrangement,

FIG. 5, a fifth cylinder head arrangement, and

FIG. 6, a plan view onto a cylinder head.

### DETAILED DESCRIPTION OF THE PREFERRED EMBODIMENTS

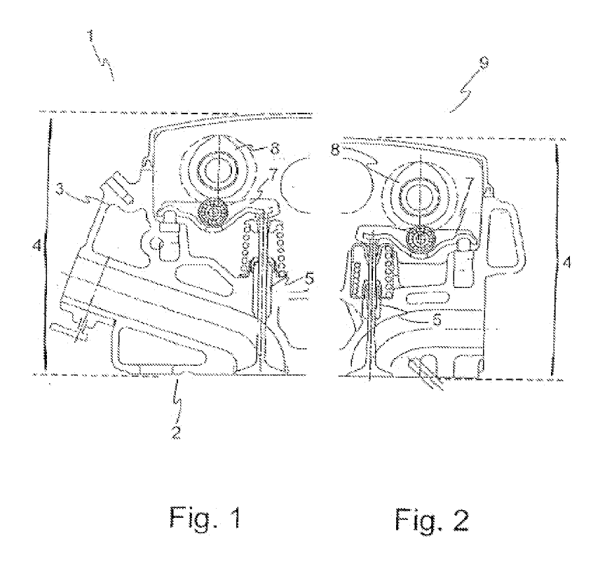

FIG. 1 shows a first cylinder head arrangement 1 according to prior art. A section through first cylinder head arrangement 1 perpendicular to a flame deck 2, as well as perpendicular to the longitudinal direction of the associated cylinder head 3 is shown. Cylinder head 3 has an overall height 4. A valve bearing bushing 5 for guiding a gas exchange valve 6 is situated in cylinder head 3. Gas exchange valve 6 is controlled by means of a cam lever 7, which is driven by a cam 8.

Below, identically functioning elements are furnished with identical reference numbers and designations.

FIG. 2 shows a second cylinder head arrangement 9 according to the invention. This accordingly is a right-hand side of the cylinder head arrangement with a lower overall height 4 provided in comparison to first cylinder head arrangement 1 from FIG. 1. The lower overall height 4 is essentially made possible by a modified valve guide. A valve bearing bushing 5 is shorter in construction than in prior art according to FIG. 1. Cam lever 7 and cam 8 are accordingly arranged lower.

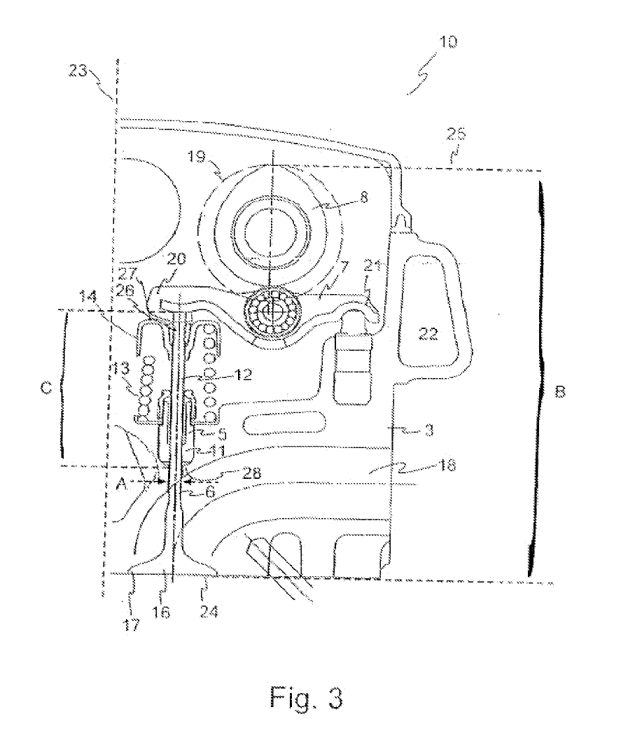

FIG. 3 shows a third cylinder head arrangement 10. This substantially corresponds to the second cylinder head arrangement 9 shown in FIG. 2, third cylinder head arrangement 3 having no cup guide, however. A valve bearing bushing 5, which has a guidance area 11 for guiding a valve stem 12 of a gas exchange valve 6, is inserted into cylinder head 3. An upper spring retainer 14 and a lower spring retainer 15 are provided to clamp in a closing spring 13. Spring 13 is shown on the left side of valve stem 12 in a position corresponding to an open position. On the right side of the valve stem, spring 13 is shown in the closed position of valve 6. A valve head 16 lying against a valve seat 17 of a gas intake port 18 represents the closed position. In an open position, not shown, valve head 16 is accordingly moved downwards. Gas exchange valve 6 is actuated by means of a cam lever 7 which is controlled by a cam 8. In this movement, cam 8 passes over an envelope circle 19 of cam 8. As cam 8 revolves, cam lever 7 is moved downwards with its oscillating end 20, so that valve 6 is opened. A fixed end 21 of cam lever 7 is seated on a cam lever bearing 22. Valve shaft 12 is parallel to a main cylinder axis 23 of a cylinder, not shown.

A valve stem diameter A in the guidance area is 4 mm. A first distance B between a lower edge 24 of valve head 16 and an upper edge 25 of oil circuit 19 of cam 8 is 136 mm relative to the cylinder's main axis 23 in the closed position of the valve as shown. A second distance C between an end face 27 provided at one end 26 of the valve for transferring an actuation force, and a lower edge 28 of valve bearing bushing 5 is 49 mm. Length 29 of the guidance area is 7 mm and thus 8% of the valve length, which is 85 mm.

A product of second distance C and valve stem diameter A divided by the square of the first distance B is 0.0106.

A product of second distance C and valve stem diameter A is 196 mm².

Length 29 of the guidance area divided by valve stem diameter A is 1.75.

Second distance C divided by guidance length 29 of the valve bearing bushing is 7.

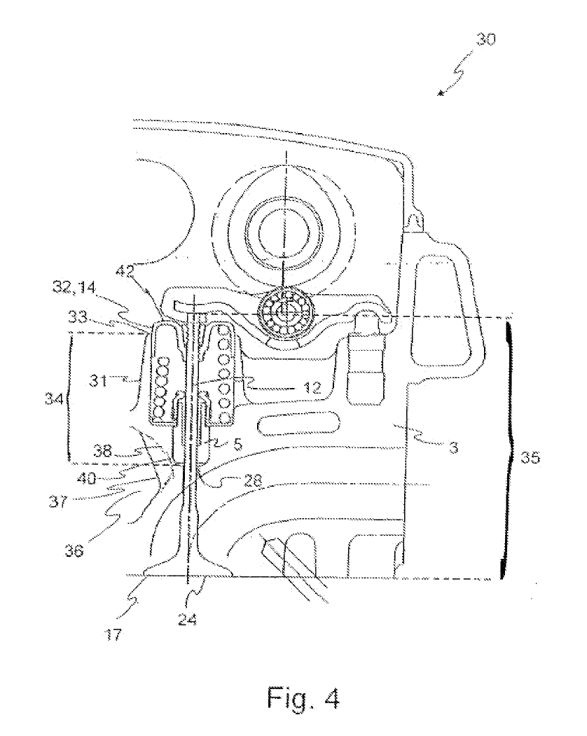

FIG. 4 shows a fourth cylinder head arrangement 30, which essentially corresponds to second cylinder head arrangement 10 shown in FIG. 3. Differently from the latter, a cup guide 31 is provided in fourth cylinder head arrangement 30. It guides a spring retainer 14 constructed as a cup 32. In particular, cup guide 31 counters transverse forces. Additionally, a second guidance length 34 is formed between a lower edge 28 of valve bearing bushing 5 and an upper edge 33 of cup guide 31. Second guidance length 34 is approximately 52% of valve length 35. Cup guide 31 is formed directly in cylinder head 3. In the configuration that is not shown, a guidance cap placed on cylinder head 3 can also be provided.

A cooling space 36 is provided for cooling valve bearing bushing 5. A first edge 37 according to a first variant is shown. A second edge 38 according to a second variant, which is intended to ensure improved cooling, is shown with a thinner line. A wall thickness 39 in an environment of valve bearing bushing 5 is roughly 2 mm. Contrary to the representation shown, a wall thickness between roughly 1 and 5 mm can be provided. Furthermore, a direct cooling of the valve bearing bushing in conjunction with an appropriate seal can be provided in a configuration that is not illustrated.

Mounting of the cup on valve stem 12 is provided by means of a thread 41. Thereby the distance between a lower edge 24 of valve head 17 and an upper edge 42 of cup 32 can be enlarged or reduced. In one embodiment, not shown, a hydraulic tappet arrangement with an automatic clearance compensation can be provided.

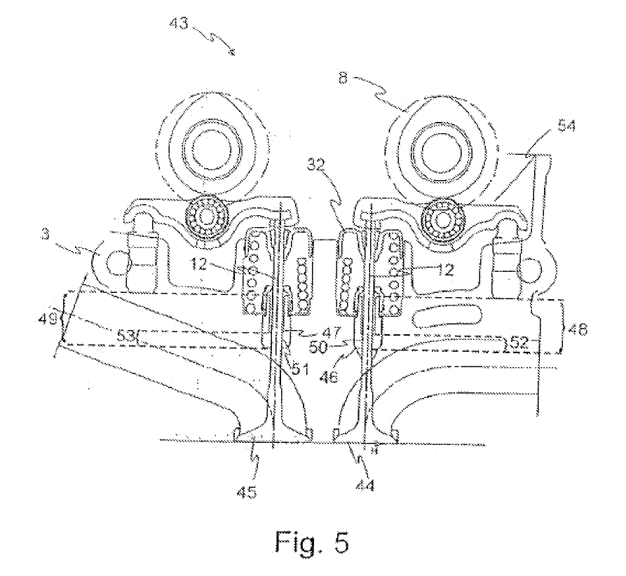

FIG. 5 shows a cutout from a cylinder head arrangement 43. An intake valve 44 and an exhaust valve 45 are provided on a cylinder, not shown. A first valve bearing bushing 46 is provided for guiding intake valve 44; a second valve bearing bushing 47 is provided for guiding exhaust valve is 45. First valve bearing bushing 46 has a first length 48, and second valve bearing bushing 47 as a second length 49. Valve bearing bushings 46, 47, as shown, differ essentially in a different design of a first guidance area 50 of the first valve bearing bushing and a second guidance area 51 of the second valve bearing bushing. A third length 52 of first guidance area 50 is approximately as large as fourth length 53 of second guidance area 51. In the case of first valve bearing bushing 46 and in the case of second valve bearing bushing 47, a ratio of third length 52 to first length 48 and a ratio of fourth length 53 to second length 49 are roughly 30%. A tilting of valve wearing bushings 46, 47 is preferably extensively prevented in cylinder head 3 by sufficient first and second lengths 48, 49.

A transition fit is selected for a seat of a first valve bearing bushing 46.

For a seat of second valve bearing bushing 47, a clearance fit is selected. In another design, not shown, the first valve bearing bushing has an oversize of 0.02 in comparison with the associated bore in cylinder head 3, not shown in detail. This can be provided for a cast-iron cylinder head. In the case of a cylinder head having a material comprising aluminum, aluminum alloy, magnesium and magnesium alloy, the first valve bearing bushing in one variant, likewise not represented, can have an oversize of up to 0.04 mm in comparison with the associated bore in the cylinder head.

In one variant, likewise not shown, a rocker arm control can be provided in place of second cam lever drive 54. Additionally, likewise not shown, direct controlling of cup 32 with cam 8 can be provided. Furthermore, an upright valve arrangement, likewise not shown, can be provided in place of an overhead valve arrangement.

For better cooling of the valve, it is provided that intake valve 44 and preferably exhaust valve 45 each have a sodium core, not shown. This sodium core is provided in a borehole, likewise not shown, in valve stem 12. This borehole forms a cavity which is approximately two-thirds filled with sodium.

In place of the mechanical valve drives shown in FIGS. 1-5, electromechanical, in particular electromagnetic, valve drives, could be provided there. Accordingly, a controlling by means of a camshaft and a cam lever shown there would be omitted, for instance, and, in particular, an electromagnetic drive would be arranged alongside the valve stem.

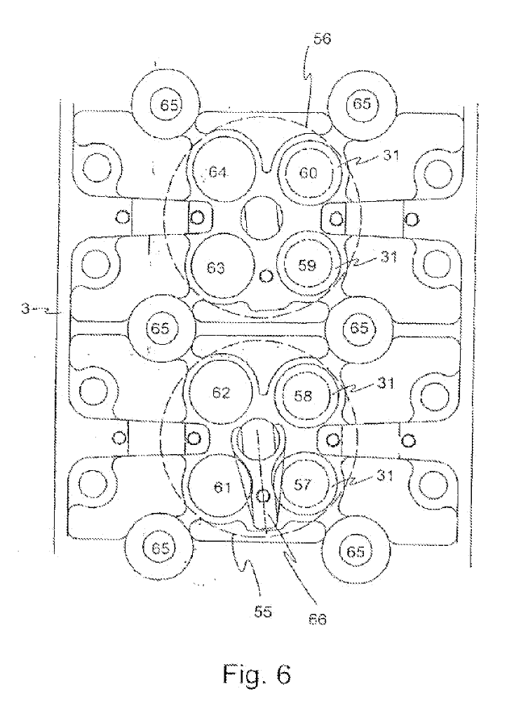

FIG. 6 shows a plan view onto a cylinder head 3. A cutout is shown with the plan view onto a respectively indicated first cylinder bore 55 and a second cylinder bore 56. Cylinder head 3 belongs to a four-cylinder internal combustion engine, the additional two cylinders not being visible in a cutout shown. Cylinder head 3 as a first intake valve opening 57, a second one 58, a third one 59 and a fourth one 60. Correspondingly, it has a first exhaust valve opening 61, a second one 62, a third one 63 and a fourth one 64. In the area of the intake valve openings, respective cup guides 31 are provided. These cup guides 31 are directly formed in cylinder head 3. Cup guides 31 serve to guide the valve, not shown. Likewise not shown is the corresponding driving mimicry of the valve. Likewise, first exhaust valve opening 61, second one 62, third one 63 and fourth one 64 can have tappet guides, not shown.

Furthermore, a number of mounting holes 65 as well as an injector retainer 66 are provided.

1. An internal combustion engine comprising at least one cylinder and at least one valve that is provided for a gas exchange and has a first end, comprising a valve head, as well as a second end, characterized in that a valve bearing has a length of a guidance area arranged for guiding a valve stem of at most 25%, preferably between 10% and 20%, and most preferably of less than 10% of a valve length.

2. The internal combustion engine according to claim 1, characterized in that the guidance area has a length of at most 18 mm, preferably between 18 mm and 10 mm, more preferably between 10 mm and 5 mm, and most preferably between 5 mm and 2 mm.

3. The internal combustion engine according to claim 1, characterized in that a valve stem diameter A in an area not guided by the valve bearing, a first distance B between a lower edge of the valve head and an upper edge of an envelope circle described during one revolution of a cam associated with the valve, and a second distance C between an end face provided at the second end of the valve for transmitting an actuation force and a lower edge of the valve bearing are selected such that a product of second distance C and valve stem diameter A divided by the square of first distance B is at most 0.0125, preferably between 0.011 and 0.0125, more preferably between 0.0105 and 0.011, and most preferably less than 0.0105, where first distance B and second distance C in the direction of a main axis of the cylinder are relative to a closed position of the valve.

4. The internal combustion engine according to claim 1, characterized in that a shaft diameter in an area guided by the valve bearing and a second distance C between an end face provided at the second end for transmitting an actuation force and a lower edge of the valve are selected such that a product of second distance C and valve stem diameter A is at most 250 mm², preferably between 230 mm² and 250 mm², more preferably between 210 mm² and 230 mm², and most preferably less than 210 mm², where second distance C in the direction of a main axis of the cylinder is relative to a closed position of the valve.

5. The internal combustion engine according to claim 1, characterized in that the length of the guidance area divided by the valve stem diameter in an area guided by the valve bearing is at most 4, preferably between 3 and 4, more preferably between 2 and 3, and most preferably less than 2.

6. The internal combustion engine according to claim 1, characterized in that relative to a closed position of the valve, a second distance C between an end face provided at the second end of the valve for transmitting an actuation force and the lower edge of the valve bearing, divided by the guidance length of the valve bearing, is at least 3, preferably between 3 and 5, more preferably between 5 and 7, and most preferably more than 7.

7. The internal combustion engine according to claim 4, characterized in that the end face is formed by a cup that is positively or non-positively connected to the second end of the valve.

8. The internal combustion engine according to claim 7, characterized in that the cup can be fixed in a longitudinal direction of the valve stem in various positions, which correspond to various end lengths of the valve.

9. The internal combustion engine according to claim 7, characterized in that the cup is guided in a cup guide.

10. The internal combustion engine according to claim 9, characterized in that a guidance length formed between a lower edge of the guidance area and an upper edge of the cup guide is between 35% and 65% of the valve length.

11. The internal combustion engine according to claim 9, characterized in that the cup guide is formed directly in a cylinder head.

12. The internal combustion engine according to claim 9, characterized in that the cup guide is formed by a cap placed on the cylinder head.

13. The internal combustion engine according to claim 1, characterized in that the valve is guided with its valve stem in a lower guide formed by the valve bearing, and with a tappet tightly connected at the upper end and forming an upper spring retainer or with a hydraulic valve clearance compensation element in an upper guide in the cylinder head, with at least one compression spring clamped between the upper spring retainer and a lower spring retainer.

14. The internal combustion engine according to claim 1, characterized in that a length of the valve bearing exceeds the length of the guidance area, preferably by at least 50%.

15. The internal combustion engine according to claim 1, characterized in that a seat of the valve bearing in the cylinder head has a clearance fit or a transition fit.

16. The internal combustion engine according to claim 1, characterized in that a seat of the valve bearing in the cylinder head having a material from the group comprising aluminum, aluminum alloy, magnesium and magnesium alloy has a fit with an oversize of less than 0.04 mm.

17. The internal combustion engine according to claim 1, characterized in that the valve has a sodium core.

18. The internal combustion engine according to claim 1, characterized in that a wall thickness between the valve bearing and at least one coolant space in an environment of the guidance area of the valve bearing is less than 5 mm, preferably between 3 mm and 5 mm, and most preferably between 1 mm and 3 mm, in at least one section.

19. The internal combustion engine according to claim 1, characterized in that it has a rocker arm control.

20. The internal combustion engine according to claim 1, characterized in that it has a cam lever control.

21. The internal combustion engine according to claim 7, characterized in that it has a direct cam shaft control of the cup.

22. The internal combustion engine according to claim 1, characterized in that the valve is an overhead valve.

23. The internal combustion engine according to claim 1, characterized in that it comprises at least one hydraulic clearance compensation element.
